(19) United States
(12) Patent Application Publication
(10) Pub. No.: US 2015/0138314 A1
(43) Pub. Date: May 21, 2015

(54) Generating Panoramic Images

(71) Applicant: Google Inc., Mountain View, CA (US)

(72) Inventor: Luc Vincent, Palo Alto, CA (US)

(73) Assignee: Google Inc., Mountain View, CA (US)

(21) Appl. No.: 14/090,483

(22) Filed: Nov. 26, 2013

Related U.S. Application Data
(60) Provisional application No. 61/906,614, filed on Nov. 20, 2013.

(51) Int. Cl. H04N 5/232; G06T 7/00; H04N 5/265; H04N 5/247

(52) U.S. Cl. CPC H04N 5/23238; H04N 5/247; G06T 7/0018; H04N 5/265; G06T 2207/10004; G06T 2207/20221
USPC 348/38

(57) ABSTRACT

Methods and systems for generating panoramic images using images captured from, for instance, a camera-enabled mobile device (e.g., a smartphone, tablet, wearable computing device, or other device) are provided. More particularly, a panoramic image can be generated from images simultaneously captured from at least two cameras facing in different directions, such as a front facing camera and a rear facing camera of a camera-enabled mobile device. The images can be captured while the photographer rotates the device about an axis. The panoramic image can then be generated from the images captured from the different cameras. The first set of images and the second set of images can be calibrated to accommodate for different positions of the cameras on the device and/or can be processed to accommodate for different resolutions of the images captured by the different cameras.

### PRIORITY CLAIM

This application claims the benefit of priority of U.S. Provisional Patent Application Ser. No. 61/906614, entitled “Generating Panoramic Images” filed on Nov. 20, 2013.

### FIELD

The present disclosure relates generally to generating panoramic images, and more particularly to generating panoramic images captured simultaneously from multiple cameras of an image capture device, such as a camera-enabled mobile device.

### BACKGROUND

The advance of mobile technology has led to the incorporation of cameras into mobile devices such as smartphones, tablets, wearable computing devices and other mobile devices. The capability of these camera-enabled mobile devices has expanded to the generation of panoramic images. A panoramic image can provide a wide angle view of a scene. Panoramic images can be generated by stitching together multiple smaller images captured of the scene. For instance, a panoramic image generation module implemented by a camera-enabled mobile device can provide a graphical user interface to guide a user through the capture a series of images (e.g. a video). Once the series of images have been captured, the images can be stitched together to generate a panoramic image.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of generating a panoramic image. The method includes obtaining, by one or more processing devices, a first set of images captured using a first camera of an image capture device. The first camera faces in a first direction. The method includes obtaining, by the one or more processing devices, a second set of images captured using a second camera of the image capture device. The second camera faces in a second direction. The second direction is different from the first direction. The second set of images is captured while the first set of images are captured using the first camera as the image capture device is rotated. The method further includes calibrating, by the one or more processing devices, a panoramic image based at least in part on one or more first images of the plurality of calibrated images and one or more second images of the plurality of second calibrated images.

Other aspects of the present disclosure are directed to systems, apparatus, tangible, non-transitory computer-readable media, user interfaces and devices for generating panoramic images.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a front view of an example camera-enabled mobile device having a front facing camera according to example embodiments of the present disclosure;

FIG. 2 depicts a back view of an example camera-enabled mobile device having a rear facing camera according to example embodiments of the present disclosure;

FIG. 3 depicts a perspective view of an example camera-enabled mobile device being manually rotated during capture of images for generating a panoramic image according to example embodiments of the present disclosure;

FIGS. 4(A)-4(D) depict the simultaneous capture of images while a camera-enabled mobile device is rotated about an axis according to an example embodiment of the present disclosure;

FIG. 5 depicts an example panoramic image generated according to example embodiments of the present disclosure;

FIG. 6 depicts a flow diagram of an example computer-implemented method for generating a panoramic image according to example embodiments of the present disclosure; and

FIG. 7 depicts a block diagram of an example computing system that can be used to implement one or more aspects of example embodiments of the present disclosure.

### DETAILED DESCRIPTION

Reference now will be made in detail to embodiments, one or more examples of which are illustrated in the drawings. Each example is provided by way of explanation of the embodiments, not limitation of the invention. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, aspects of the present disclosure are directed to generating panoramic images using images captured from, for instance, a camera-enabled mobile device (e.g., a smartphone, camera phone, tablet, wearable computing device, or other device). Capturing images for panoramic images using camera-enabled mobile devices can sometimes present various challenges. For instance, a panoramic image generation module implemented, all or in part, on a smartphone can provide a user interface on a display of the smartphone to guide the photographer in capturing images with proper alignment for generation of the panoramic image. The photographer can be required to rotate with the smartphone as the images are captured so that the photographer can see the user interface on the display during the capture of images.

It can be difficult for a photographer to rotate with the smartphone as required, for instance, when the photographer is in a cramped environment. In addition, it can be difficult to generate a panoramic image depicting the photographer (e.g. a “selfie” panorama) because it would require capture of images of the photographer while the photographer cannot see the display of the smartphone. As a result, the photographer can be unable to capture images depicting the photographer with proper alignment for purposes of generation of the panoramic image.

According to example aspects of the present disclosure, a panoramic image can be generated from images simultaneously captured from two cameras facing in different directions. For instance, an image capture device, such as a smartphone, can have a first camera facing in a first direction and a second camera facing in a second different direction. A photographer can simultaneously capture images using the first camera and the second camera while the photographer rotates the image capture device about an axis. The panoramic image can then be generated from the images captured from both the first camera and the second camera.

As an example, a photographer can initiate a panoramic image generation module on a camera-enabled mobile device, such as a smartphone, having a front facing camera and a rear facing camera. The photographer can hold the camera-enabled mobile device with his/her arm extended. The photographer can then simultaneously capture images using the front facing camera and the rear facing camera as the photographer rotates the camera-enabled mobile device. The first half of the panoramic image depicting, for instance, the scene in front of the photographer, can be generated from images captured from the rear facing camera. The second half of the panoramic image depicting, for instance, the photographer, can be generated from the front facing camera. In this way, a photographer can capture images necessary to generate a panoramic image in half of the time and using half of a rotation of a camera-enabled mobile device. Moreover, the capture of images using the front facing camera can allow for the capture of images depicting the photographer for generation of a selfie panorama while still allowing the photographer to view a user interface guiding the photographer through the capture of images.

The images captured from the first and second cameras can be stitched together to generate the panoramic image. More particularly, a first set of images captured from the first camera and a second set of images captured from a second camera can be accessed and processed (e.g. using a panoramic image stitching process) to generate the panoramic image. According to example embodiments of the present disclosure, the first set of images and the second set of images can be calibrated to accommodate for different positions of the first camera and the second camera on the image capture device. In addition, the resolution of images captured from the first camera can, in some cases, be different from the resolution of images captured from the second camera. As an example, images captured using the front facing camera of a smartphone can be lower resolution than images captured using the rear facing camera. According to example aspects of the present disclosure, the images can be processed such that the images captured from first and second cameras have the same resolution.

The generation of panoramic images according to example aspects of the present disclosure can allow for a photographer to more easily capture panoramic images in cramped environments. More particularly, the photographer is no longer required to rotate with the camera-enabled mobile device. Rather the photographer simply needs to rotate the camera-enabled mobile device about an axis for approximately 180° of rotation or less. Moreover, capturing images while rotating the camera-enabled mobile device about an axis can reduce parallax, resulting in higher quality stitching of panoramic images.

### Example Image Capture Devices

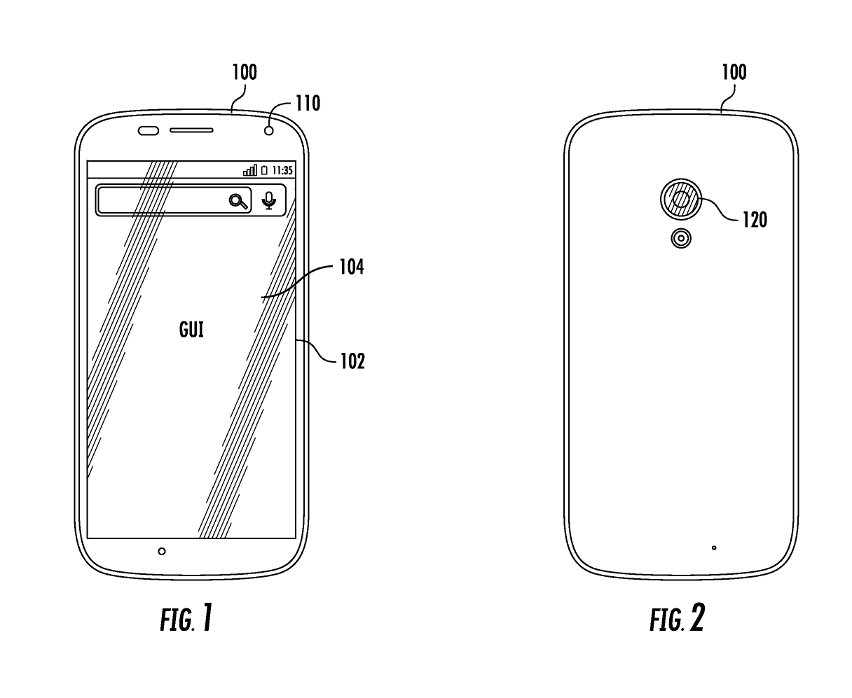

FIG. 1 depicts a front view of an example image capture device 100 that can be used to capture images for generating a panoramic image according to example aspects of the present disclosure. The image capture device 100 is a camera-enabled mobile device. As used herein, a camera-enabled mobile device refers to a mobile computing device capable of being carried by a user (e.g. a smartphone, tablet, camera phone, PDA, wearable computing device or other portable computing device) that includes an integrated camera configured to capture digital images. A camera-enabled mobile device can have a primary functionality other than capturing images. For instance, the image capture device 100 of FIG. 1 can be a smartphone.

Aspects of the present disclosure will be discussed with reference to a smartphone for purposes of illustration and discussion. Those of ordinary skill in the art, using the disclosures provided herein, will understand that other image capture devices can be used without deviating from the scope of the present disclosure, such as tablets, camera phones, wearable computing devices, etc.

The image capture device 100 includes a display 102. A graphical user interface 104 can be presented on the display 102. The graphical user interface 104 can allow a user to implement various functionality of the image capture device 100. For instance, the graphical user interface 104 can allow a user to access a camera application that allows a user to capture digital images. The digital images can be captured using various cameras on the image capture device.

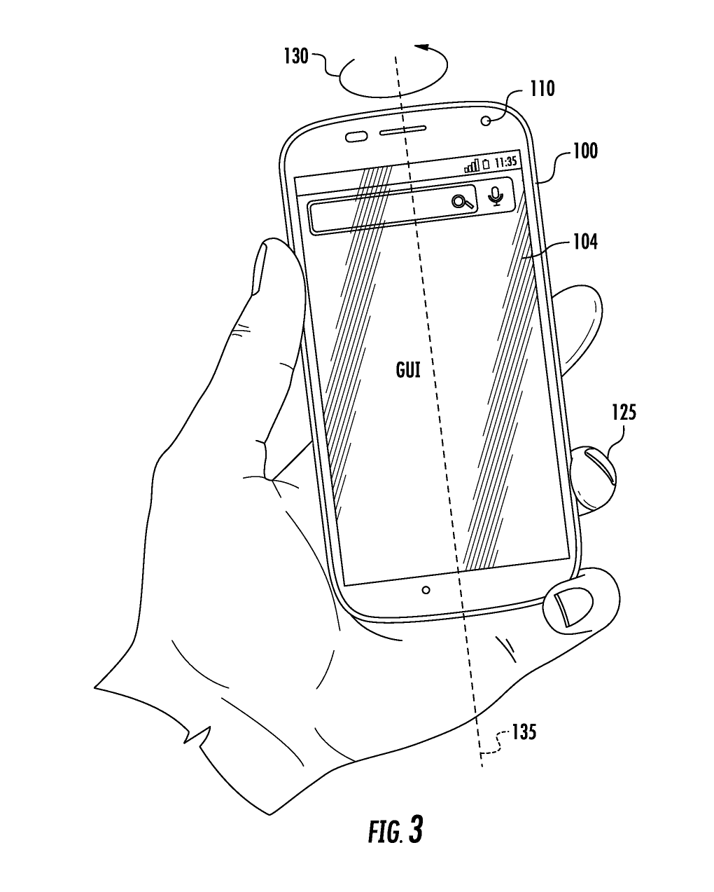

More particularly, the image capture device 100 can include a front facing camera 110 that faces in a first direction relative to the image capture device 100. Referring to FIG. 2, the image capture device 100 can further include a rear facing camera 120 that faces in a second direction relative to the image capture device 100. The front facing camera 110 and the rear facing camera 120 can be located at different positions relative to the center of the image capture device 100. More specifically, the front facing camera 110 can be located in an upper right position of the image capture device 100 (when looking at the display 102). The rear facing camera 120 can be more centrally located on the back of the image capture device 100 (FIG. 2). In addition, the front facing camera 110 and the rear facing camera 120 can be configured to capture images at differing resolutions. For instance, the front facing camera 110 can be configured to capture images at a lower resolution than images captured by the rear facing camera 120.

A camera application implemented on the image capture device 100 can allow a user to capture images using the front facing camera 110 and/or the rear facing camera 120. According to example aspects of the present disclosure, images can be acquired by the front facing camera 110 and the rear facing camera 120 simultaneously (e.g. at the same time) as the image capture device 100 is rotated about an axis. These images can then be used to generate a panoramic image as will be discussed in more detail below.

### Example Capture of Images for Generating a Panoramic Image

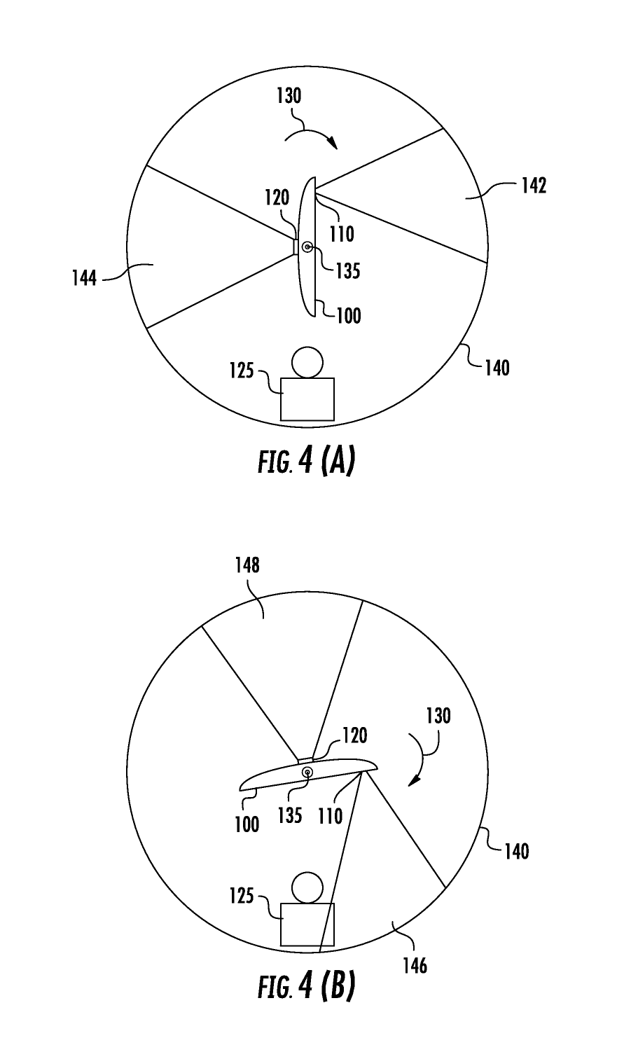

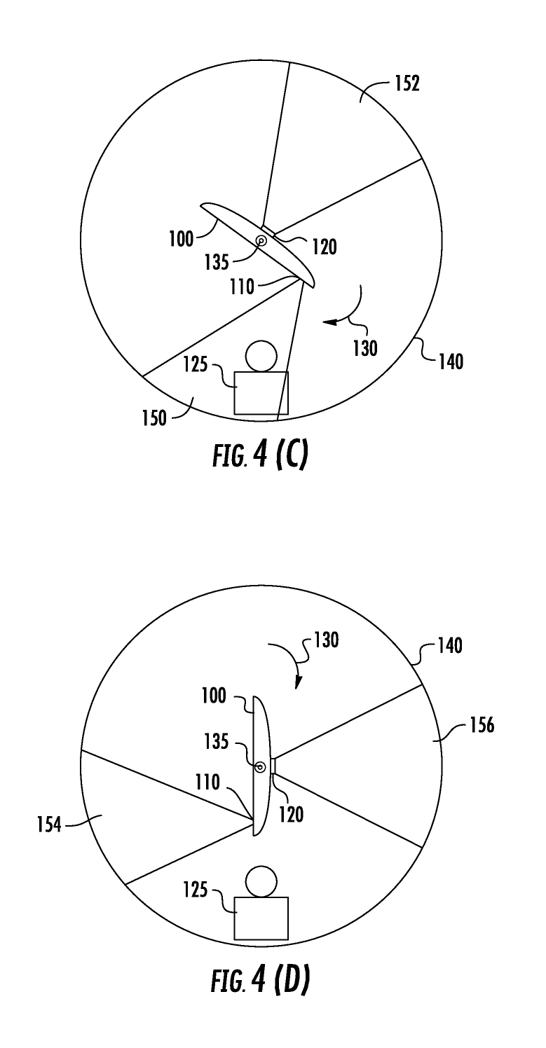

With reference to FIGS. 3 and 4(A)-4(D), the capture of images for generating a panoramic image according to example embodiments of the present disclosure will be discussed in more detail. FIG. 3 depicts the image capture device 100 being manually held by a photographer 125. As shown, the front facing camera 110 of the image capture device 100 at least partially faces in the direction of the photographer 125. The rear facing camera (not shown in FIG. 3) can face in a different direction, such as the opposite direction relative to the front facing camera 110.

To generate a panoramic image, the photographer 125 can rotate the image capture device 100 while simultaneously capturing images from the front facing camera 110 and the rear facing camera 120. For instance, the photographer 125 can rotate the image capture device 100 in the direction indicated by arrow 130 about an axis 135 associated with the image capture device 100. The axis 135 in FIG. 3 is a vertical axis along the length of the image capture device 100. The axis can be other axes associated with the image capture device 100, such as a horizontal axis, diagonal axis, or other axis.

In particular aspects, the image capture device 100 can be rotated 180° or less during capture of the images using the front facing camera 110 and the rear facing camera 120. The images can be captured from the front facing camera 110 and the rear facing camera 120, for instance, by capturing a video or series of images. Rotating the image capture device 100 can allow the photographer 125 to capture images while still viewing the display 102 of the image capture device 100. As a result, the photographer can still view and interact with a graphical user interface. In particular implementations, the graphical user interface can guide the photographer 125 through the capture of images for generation of a panoramic image.

FIGS. 4(A)-4(D) depict the example capture of images of a scene 140 using the front facing camera 110 and the rear facing camera 120 of the image capture device 100 while rotating 180° about an axis 135. The scene 140 extends 360° around the image capture device 100. The image capture device 100 can capture images of a scene that extends less than 360° around the image capture device without deviating from the scope of the present disclosure.

In FIG. 4(A), the image capture device 100 is illustrated in a first position during rotation of the image capture device 100 about axis 135. In this position, the image capture device 100 captures images of the scene 140 to the left and right of the photographer 125. More particularly, the front facing camera 110 can capture one or more images of portion 142 of the scene 140. The rear facing camera 120 can capture one or more images of portion 144 of the scene 140.

In FIG. 4(B), the image capture device 100 is illustrated in a second position during rotation of the image capture device 100 about axis 135. In this position, the image capture device 100 captures images of the scene 140 in front of and behind the photographer 125. More particularly, the front facing camera 110 can capture one or more images of portion 146 of the scene 140. The rear facing camera 120 can capture one or more images of portion 148 of the scene 140. As shown, one or more images of portion 146 of the scene 140 can depict at least a part of the photographer 125.

In FIG. 4(C), the image capture device 100 is illustrated in a third position during rotation of the image capture device 100 about axis 135. In this position, the image capture device 100 captures images of the scene 140 in front of and behind the photographer 125. More particularly, the front facing camera 110 can capture one or more images of portion 150 of the scene 140. The rear facing camera 20 can capture one or more image of portion 152 of the scene 140. As shown, one or more images of portion 150 of the scene 140 can also depict at least a part of the photographer 125.

In FIG. 4(D), the image capture device 100 is illustrated in a fourth position during rotation of the image capture device 100 about axis 135. In this position, the image capture device 100 captures images of the scene 140 to the left and right of the photographer 125. More specifically, the front facing camera 110 can capture one or more images of portion 156 of the scene 140. The rear facing camera 120 can capture one or more images of portion 158 of the scene 140.

As will be discussed in more detail below, the images captured by the front facing camera 110 and the images captured by the rear facing camera 120 can be processed, for instance, to adjust the resolution of the images and to calibrate the images to a reference camera position. The images can then be stitched together to generate a panoramic image of the scene 140.

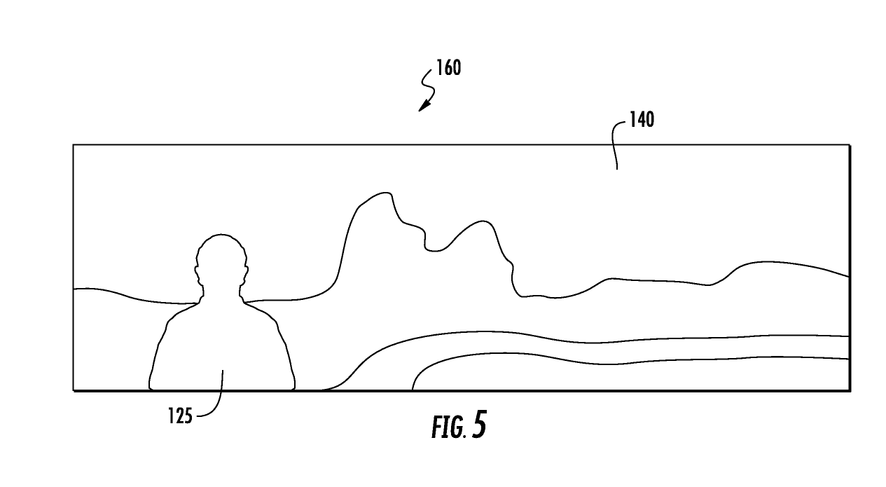

FIG. 5 depicts an example panoramic image 160 generated from images captured of scene 140 according to example aspects of the present disclosure. As shown, the panoramic image 160 can provide a 360° view (or less) of the scene 140. Because the photographer 125 was included in images captured of portions of the scene 140 (e.g. portion 146 of FIG. 4(B) and portion 150 of FIG. 4(C)), the photographer 125 can be depicted in the panoramic image 160.

### Example Methods for Generating a Panoramic Image

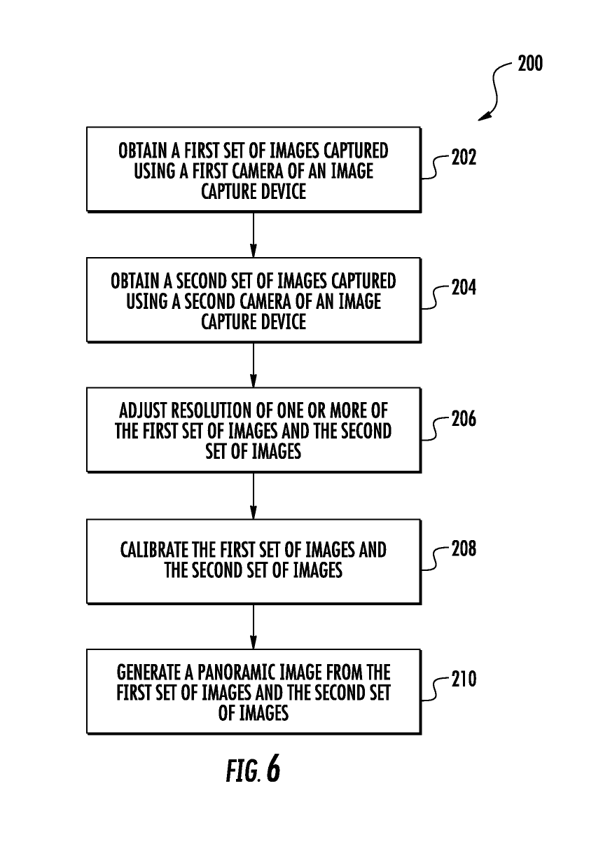

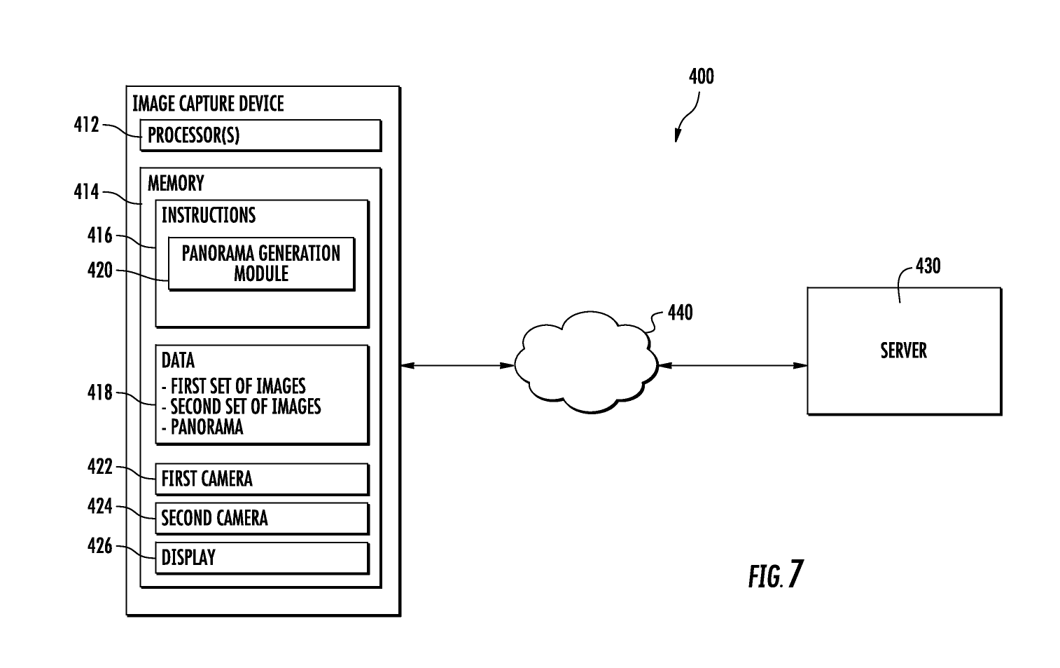

FIG. 6 depicts a flow diagram of an example method (200) for generating a panoramic image according to example aspects of the present disclosure. FIG. 6 can be implemented by one or more processing devices, such as one or more of the processing devices depicted in FIG. 7. For instance, one or more steps of the method (200) can be implemented by one or more processing devices on an image capture device. Alternatively and/or in addition, one or more steps of the method can be implemented by one or processing devices at a remote device, such as a server. FIG. 6 depicts steps performed in a particular order for purposes of illustration and discussion. Those of ordinary skill in the art, using the disclosures provided herein, will understand that various steps of any of the methods disclosed herein can be omitted, adapted, modified, expanded, and/or rearranged in various ways without deviating from the scope of the present disclosure.

At (202), the method includes obtaining a first set of images captured using a first camera of an image capture device. As used herein, obtaining the first set of images can include, for instance, receiving images at a processing device, accessing images stored in a memory, obtaining images from a remote device, or actually capturing images using a camera. The first camera can face a first direction relative to the image capture device. For instance, the first camera can be a rear facing camera on a camera-enabled mobile device.

At (204), the method includes obtaining a second set of images captured using a second camera of the image capture device. As used herein, obtaining the second set of images can include, for instance, receiving images at a processing device, accessing images stored in a memory, obtaining images from a remote device, or actually capturing images using a camera. The second camera can face a second direction relative to the image capture device. For instance, the second camera can be a front facing camera on a camera-enabled mobile device.

According to example aspects of the present disclosure, the second set of images can be captured by the second camera while the first set of images are captured by the first camera as the image capture device is rotated. For instance, the first set of images and the second set of images can be captured simultaneously while rotating the image capture device about an axis as illustrated in FIGS. 4(A)-4(D). In a particular implementation, the image capture device can be manually rotated about the axis by the photographer.

As discussed above, the images captured by the first camera of an image capture device can have a resolution that is different from a resolution of images captured by the second camera of the image capture device. To address the differing resolution of the images, the method can optionally include adjusting a resolution of one or more of the first set of images and the second set of images (206). More particularly, one or more of the first set of images and the second set of images can be processed such that the first set of images and the second set of images have the same resolution.

As an example, the first camera of the image capture device can be a rear facing camera of a camera-enabled mobile device. The second camera can be a front facing camera of a camera-enabled mobile device. The front facing camera can be configured to capture images at a lower resolution relative to images captured by the rear facing camera. In this example, adjusting the resolution of the images such that the first set of images and the second set of images have the same resolution can include upsampling the second set of images captured by the front facing camera. Alternatively and/or in addition, adjusting the resolution of the images such that the first set of images and the second set of images have the same resolution can include downsampling the images captured by the front facing camera. To the extent the first camera and the second camera capture images of the same portion of the scene, images with higher resolution can be given priority in generation of the panoramic image relative to images with lower resolution.

To generate a panoramic image, the positions of the captured images relative to some reference need to be determined such that the images can be properly aligned for generation of the panoramic image. In certain cases, the first camera and the second camera can be located at different locations relative to a reference on the image capture device. For instance, the front facing camera 110 of the image capture device 100 of FIG. 1 is located in the upper right portion of the image capture device 100 (when looking at the display 102). The rear facing camera 120 is more centrally located on the image capture device 100.

To accommodate the differing positions of the cameras relative to a reference, the method can further include calibrating the first set of images and the second set of images to generate a first set of calibrated images and a second set of calibrated images as shown at (208). The calibrated images can be associated with positions relative to the same reference camera position.

For instance, according to a particular aspect of the present disclosure, a reference camera position can be identified for the image capture device. The reference camera position can be at any location on the image capture device or other suitable location. In one particular embodiment, the reference camera position can be a position associated with either the first camera or the second camera. Once the reference camera position has been identified, the first set of images and/or the second set of images can be calibrated to the reference camera position.

For example, the first set of calibrated images can be generated by identifying the position of one or more of the first set of images relative to the first camera. The position of the one or more images can be modified to be relative to the reference camera position. The position of the images can be modified based at least in part on the difference in position between the reference camera position and the position of the first camera. If the reference camera position is the same as the position of the first camera, the first set of images are already calibrated to the reference camera position and can serve as the first set of calibrated images.

Similarly, the second set of calibrated images can be generated by identifying the position of one or more of the second set of images relative to the second camera. The position of the one or more images can be modified to be relative to the reference camera position. The position of the images can be modified based at least in part on the difference in position between the reference camera position and the position of the second camera. If the reference camera position is the same as the position of the second camera, the second set of images are already calibrated to the reference camera position and can serve as the second set of calibrated images.

At (210), the method can include generating a panoramic image from the calibrated images. Various techniques can be used to generate the panoramic image. For instance, in one implementation, one or more first images from the first set of calibrated images and one or more second images from the second set of calibrated images can be aligned according to their positions relative to the reference camera position. In cases where images overlap, portions with higher image quality and/or resolution can be given priority in generation of the panoramic image. One or more first images and one or more second images can then be stitched together to generate the panoramic image.

### Example Systems for Generating a Panoramic Image

FIG. 7 depicts an example system 400 for generating a panoramic image according to example embodiments of the present disclosure. The system 400 can include an image capture device 410, such as a camera-enabled mobile device. The image capture device 410 can be, for instance, a smartphone, camera phone, tablet, PDA, wearable computing device, or other suitable mobile device. The image capture device 410 can include an integrated first camera 422 and an integrated second camera 424. The first camera 422 and the second camera 424 can face in different directions. For instance, the first camera 422 can be a rear facing camera of the image capture device 410. The second camera 424 can be a front facing camera of the image capture device 410. The first camera 422 and the second camera 424 can be any device configured to capture digital images of target objects or scenes. The first camera 422 and the second camera 424 can include video capability for capturing a sequence of images/video.

The image capture device 410 can further include one or more processor(s) 412 and a memory 414. The one or more processor(s) 412 can be any suitable processing device, such as a microprocessor, microcontroller, integrated circuit, or other suitable processing device. The memory 414 can include one or more computer-readable media, including, but not limited to, non-transitory computer-readable media, RAM, ROM, hard drives, flash drives, or other memory devices. The memory 414 can store information accessible by processor(s) 412, including data 418 that can be retrieved, manipulated, created, or stored by processor(s) 412. The data 418 can include, for instance, a first set of images captured by the first camera 422, a second set of images captured by the second camera 424, panoramas generated according to example aspects of the present disclosure, and/or other data.

The memory 414 can also store computer-readable instructions 416 that can be executed by processor(s) 412. The instructions 416 can be any set of instructions that when executed by the processor(s) 412, cause the processor(s) 412 to provide desired functionality. For instance, the instructions 416 can be executed by the processor(s) 412 to implement a camera application and/or a panorama generation module 420. The panorama generation module 420 can be configured to generate a panoramic image according to example aspects of the present disclosure, for instance, by implementing the method (200) of FIG. 6. The panorama generation module 420 can provide other functionality. For instance, the panorama generation module 420 can implement a user interface that allows a photographer to capture images using both the first camera 422 and the second camera 424 simultaneously. The user interface can also guide the photographer through capture of the properly aligned images using the first camera 422 and the second camera 424 for generation of a panoramic image.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

The image capture device 410 can include one or more input/output devices. Input devices may correspond to one or more devices configured to allow a user to interact with the computing device. Example input devices can include a touch interface suitable for receiving touch commands from a user. Output devices can correspond to a devices used to provide information to a user. One example output device includes a display 426 for presenting images, graphical user interfaces, and information to user. The image capture device 410 can include other input/output devices, such as a keypad, microphone, audio system, and/or other suitable input/output devices.

The image capture device 410 can also include a network interface that allows the image capture device 410 to communicate with one or more remote devices, such as server 430, over a network 440. The network interface can include any suitable components for interfacing with one more networks, including for example, transmitters, receivers, ports, controllers, antennas, or other suitable components.

The server 430 can include one or more processing devices and one or more computer-readable media. In certain embodiment, the server 430 can be configured to receive images captured from the image capture device 410, for instance, over the network 440. The server 430 can then generate the panoramic image according to example aspects of the present disclosure. The server 430 can then communicate the generated panoramic image to the image capture device 430 for presentation to a user.

The network 440 can be any type of communications network, such as a local area network (e.g. intranet), wide area network (e.g. Internet), or some combination thereof. The network 440 can also include a direct connection between the image capture device 410 and the server 430. In general, communication between the image capture device 410 and the server 430 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, modules, software applications, and other computer-based systems, as well as actions taken and information sent to and from such systems. Those of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of generating a panoramic image, the method comprising:
obtaining, by one or more processing devices, a first set of images captured using a first camera of an image capture device, the first camera facing in a first direction;
obtaining, by the one or more processing devices, a second set of images captured using a second camera of the image capture device, the second camera facing in a second direction, the second direction being different from the first direction, the second set of images being captured while the first set of images are captured using the first camera during a rotation of the image capture device;
calibrating, by the one or more processing devices, the first set of images and the second set of images to generate a plurality of first calibrated images and a plurality of second calibrated images; and
generating, by the one or more processing devices, a panoramic image based at least in part on one or more first images of the plurality of first calibrated images and one or more second images of the plurality of second calibrated images.

2. The method of claim 1, wherein the first set of images have a different resolution than the second set of images.

3. The method of claim 2, wherein the method comprises processing, by the one or more processing devices, one or more of the first set of images and the second set of images such that the first set of images and the second set of images have the same resolution.

4. The method of claim 3, wherein processing, by the one or more processing devices, the first set of images and the second set of images such that the first set of images and the second set of images have the same resolution comprises downsampling, by the one or more processing devices, the first set of images.

5. The method of claim 3, wherein processing, by the one or more processing devices, the first set of images and the second set of images such that the first set of images and the second set of images have the same resolution comprises upsampling, by the one or more processing devices, the second set of images.

6. The method of claim 1, wherein calibrating, by the one or more processing devices, the first set of images and the second set of images to generate a plurality of first calibrated images and a plurality of second calibrated images comprises:
determining, by the one or more processing devices, a reference camera position for the image captured device; and
calibrating, by the one or more processing devices, the first set of images and the second set of images based at least in part on the reference camera position.

7. The method of claim 1, wherein the one or more processing devices are a part of the image capture device.

8. The method of claim 1, wherein the image capture device is a camera-enabled mobile device.

9. The method of claim 8, wherein the first camera is a rear facing camera of the camera-enabled mobile device and the second camera is a front facing camera of the camera-enabled mobile device.

10. The method of claim 1, wherein the first set of images and the second set of images are captured while the image capture device is rotated about an axis associated with the image capture device.

11. The method of claim 1, wherein the first set of images and the second set of images are captured while the image capture device is rotated 180° or less.

12. The method of claim 1, wherein the first set of images and the second set of images are captured simultaneously while the image capture device is manually rotated by a photographer about an axis associated with the image capture device.

13. The method of claim 12, wherein the panoramic image depicts at least a portion of the photographer.

14. A camera-enabled mobile device, comprising:
a front facing camera;
a rear facing camera;
one or more processors and one or more computer-readable media, the one or more computer-readable media storing computer-readable instructions that when executed by the one or more processors cause the one or more processors to perform operations, the operations comprising:
obtaining a first set of images captured using the rear facing camera of the camera-enabled mobile device;
obtaining a second set of images captured using the front facing camera of the image capture device, the second set of images being captured while the first set of images are captured using the rear facing camera;
calibrating the first set of images and the second set of images to generate a plurality of first calibrated images and a plurality of second calibrated images; and
generating a panoramic image based at least in part on one or more first images of the plurality of first calibrated images and one or more second images of the plurality of second calibrated images.

15. The camera-enabled mobile device of claim 14, wherein the front facing camera is configured to capture the second set of images at a lower resolution than the first set of images captured by the rear facing camera.

16. The camera-enabled mobile device of claim 15, wherein the operations further comprise processing at least one of the first images and the second images such that the first images and the second images have the same resolution.

17. The camera-enabled mobile device of claim 15, wherein the operation of calibrating the first set of images and the second set of images to generate a plurality of first calibrated images and a plurality of second calibrated images comprises:
determining, by the one or more processing devices, a reference camera position for the image capture device; and
calibrating, by the one or more processing devices, the first set of images and the second set of images based at least in part on the reference camera position.

18. One or more non-transitory computer-readable media storing computer-readable instructions that when executed by one or more processors cause the one or more processors to perform operations, the operations comprising:
obtaining a first set of images captured using a first camera of an image capture device, the first camera facing in a first direction, the first set of images having a first resolution;
obtaining a second set of images captured using a second camera of the image capture device, the second camera facing in a second direction, the second direction being different from the first direction, the second set of images being captured while the first set of image images are captured by the first camera of the image capture device as the image capture device is rotated, the second set of images having a second resolution, the second resolution being different from the first resolution;
processing the first set of images and the second set of images such that the first set of images and the second set of images have the same resolution; and
generating a panoramic image based at least in part on one or more first images of the first set of images and one or more second images of the second set of images.

19. The one or more non-transitory computer-readable media of claim 18, wherein the operations further comprise calibrating the first set of images and the second set of images to generate a plurality of first calibrated images and a plurality of second calibrated images.

20. The one or more non-transitory computer-readable media of claim 19, wherein the operation of calibrating the first set of images and the second set of images to generate a plurality of first calibrated images and a plurality of second calibrated images comprises:
determining, by the one or more processing devices, a reference camera position for the image capture device; and
calibrating, by the one or more processing devices, the first set of images and the second set of images based at least in part on the reference camera position.
